(19) United States
(12) Patent Application Publication
(10) Pub. No.: US 2006/0162481 A1
(43) Pub. Date: Jul. 27, 2006

(54) Operating pedal system of automobile

(75) Inventor: Jun Sato, Haga-gun (JP)

Correspondence Address: ARENT FOX PLLC, 1050 CONNECTICUT AVENUE, N.W., SUITE 400, WASHINGTON, DC, 20036, US

(73) Assignee: F. TECH INCORPORATION

(21) Appl. No.: 11/296,565

(22) Filed: Dec. 8, 2005

(30) Foreign Application Priority Data
Dec. 9, 2004 (JP) 2004-356978

(51) Int. Cl. G05G 1/14

(52) U.S. Cl. 74/512

(57) ABSTRACT

A long hole is provided on a bracket fixedly provided on a rear face of a dashboard such that the long hole is adjacent to a support hole supporting a pivot of an operating pedal with a partition wall provided between the long hole and the long hole. Also, a control lever is pivotally supported on a front face of the pivot via the operating pedal such that a lower arm of the control lever faces the front face. A stopper member fixedly provided on a vehicle body faces an upper arm of the control lever from behind. Therefore, when the control lever abuts against the stopper member and rotates as the dashboard is deformed rearward, the pivot breaks the partition wall to move rearward within the long hole due to an excessive load received from the control lever. Thus, the support hole of the pivot of the operating pedal can be formed into a circular shape conforming to an outer peripheral face of the pivot, so that no rattling occurs between the support hole and the pivot. Further, when the dashboard is deformed rearward, the pivot is moved rearward to prevent a tread portion of the operating pedal from coming closer to a driver.

### RELATED APPLICATION DATA

The present invention is based upon Japanese priority application No. 2004-356978, which is hereby incorporated in its entirety herein by reference.

### BACKGROUND OF THE INVENTION

1. Field of the Invention

The present invention relates to an operating pedal system of an automobile in which an operating pedal for operating an operation device mounted on a front face of a dashboard of a vehicle body or a relay lever associated with the operating pedal is mounted on a bracket fixedly provided on a rear face of the dashboard via a pivot, and particularly to an improvement of an operating pedal system in which, even when a dashboard supporting the bracket is deformed rearward upon head-on collision of the vehicle, the pivot is moved rearward to prevent a tread portion of the operating pedal from coming closer to a driver.

2. Description of the Related Art

Japanese Patent Application Laid-open Nos. 11-139346 and 2001-47986 disclose operating pedal systems in which, even when a dashboard supporting a bracket is deformed rearward upon head-on collision of a vehicle, a tread portion of an operating pedal does not come closer to a driver.

In either operating pedal system disclosed in Japanese Patent Application Laid-open Nos. 11-139346 and 2001-47986, a release hole is provided in a bracket such that the release hole communicates with a support hole supporting a pivot of an operating pedal in order to release the pivot rearward as a dashboard supporting the bracket is deformed rearward upon head-on collision of a vehicle. Therefore, they have a disadvantage that the support hole has an imperfectly circular shape, and thus rattling is likely to occur on the release hole side between an inner peripheral face of the support hole and the pivot, resulting in an deteriorated operation feeling of the operating pedal.

### SUMMARY OF THE INVENTION

The present invention has been achieved in view of the above circumstances, and has an object to provide an operating pedal system of an automobile in which a support hole of a pivot of an operating pedal is formed into a circular shape conforming to an outer peripheral face of the pivot, no rattling occurs between the support hole and the pivot, thereby providing an excellent operation feeling, and in which when a dashboard is deformed rearward, the pivot is moved rearward to prevent a tread portion of the operating pedal from coming closer to a driver.

In order to achieve the above object, according to a first feature of the present invention, there is provided an operating pedal system of an automobile in which an operating pedal for operating an operation device mounted on a front face of a dashboard of a vehicle body or a relay lever associated with the operating pedal is mounted on a bracket fixedly provided on a rear face of the dashboard via a pivot, wherein a support hole supporting the pivot and a long hole adjacent to the support hole and extending rearward thereof are pivotally supported on the bracket such that a partition wall is provided between the support hole and the long hole, a control lever is pivotally supported on a front face of the pivot via the operating pedal or the relay lever such that a lower arm of the control lever faces the front face, and a stopper member fixedly provided on a reinforcement member of the vehicle body faces an upper arm of the control lever from behind, so that, when the control lever abuts against the stopper member and rotates as the dashboard is deformed rearward, the pivot breaks the partition wall to move rearward within the long hole due to an excessive load received from the control lever.

The operation device corresponds to a negative pressure booster 4 in embodiments described later, the operating pedal corresponds to a brake pedal 10 in the embodiments, and the reinforcement member corresponds to a steering hanger beam 22 in the embodiments.

With the first feature of the present invention, the support hole can be formed into a circular shape conforming to the outer peripheral face of the pivot by virtue of the partition wall, and therefore no rattling occurs between the support hole and the pivot, thus providing an excellent operation feeling of the operating pedal. Moreover, when the dashboard is deformed rearward, the control lever abuts against the stopper member and rotates, and the pivot breaks the partition wall to move rearward within the long hole due to the excessive load received from the control lever, so that the operating pedal rotates to shift its tread portion forward, whereby the tread portion can be prevented from coming closer to a driver.

According to a second feature of the present invention, in addition to the first feature, a fragile portion to be broken by the excessive load is provided at one end of the partition wall, and a recess receiving the partition wall deformed by the breakage of the fragile portion is formed on one side of the long hole.

With the second feature of the present invention, the broken partition wall is pushed into the recess, whereby the pivot can be reliably moved within the long hole without being interrupted by the partition wall.

The above-mentioned object, other objects, characteristics, and advantages of the present invention will become apparent from preferred embodiments which will be described in detail below with reference to the attached drawings.

### BRIEF DESCRIPTION OF THE DRAWINGS

FIG. 1 is a perspective view of an operating pedal system of an automobile according to a first embodiment of the present invention.

FIG. 2 is a side view of the operating pedal system.

FIG. 3 is a view of a part shown by an arrow 3 in FIG. 2.

FIG. 4 is an enlarged sectional view taken along line 4-4 in FIG. 2.

FIG. 5 is an enlarged cross-sectional side view of essential parts in FIG. 2.

FIG. 6 is an explanatory view of an operation corresponding to FIG. 2.

FIG. 7 is an explanatory view of an operation corresponding to FIG. 5.

FIG. 8 is a perspective view of an operating pedal system of an automobile according to a second embodiment of the present invention.

FIG. 9 is a side view of the operating pedal system.

FIG. 10 is an explanatory view of an operation corresponding to FIG. 9.

FIG. 11 is a view showing a third embodiment of the present invention and corresponding to FIG. 9.

### DESCRIPTION OF THE PREFERRED EMBODIMENTS

The preferred embodiments of the present invention will be described below with reference to the drawings.

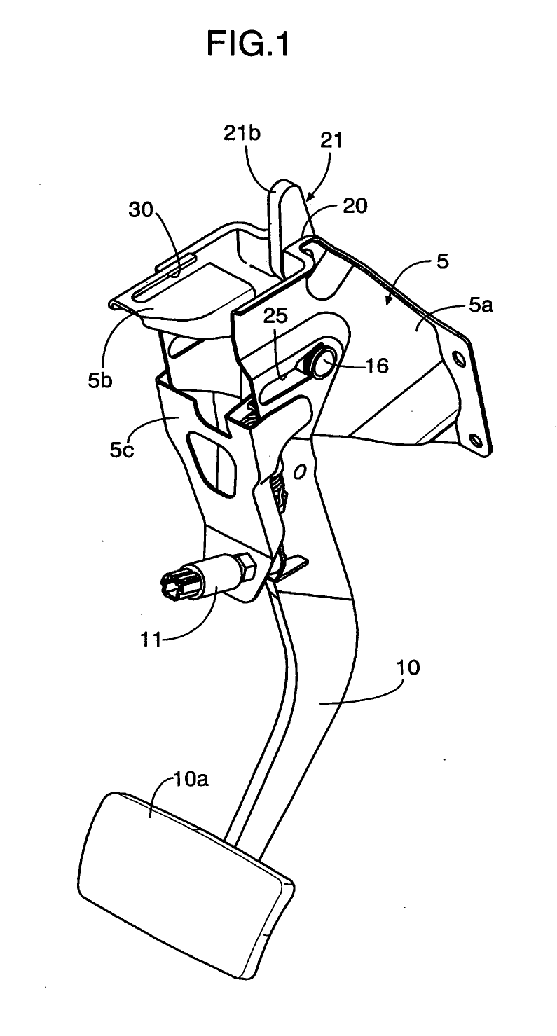

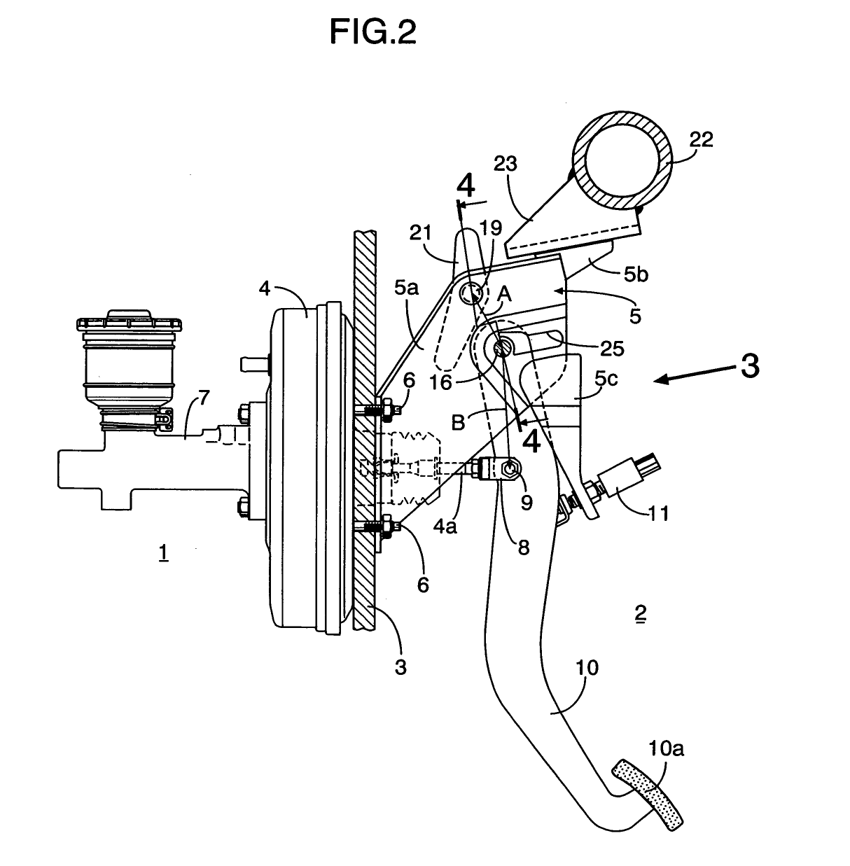

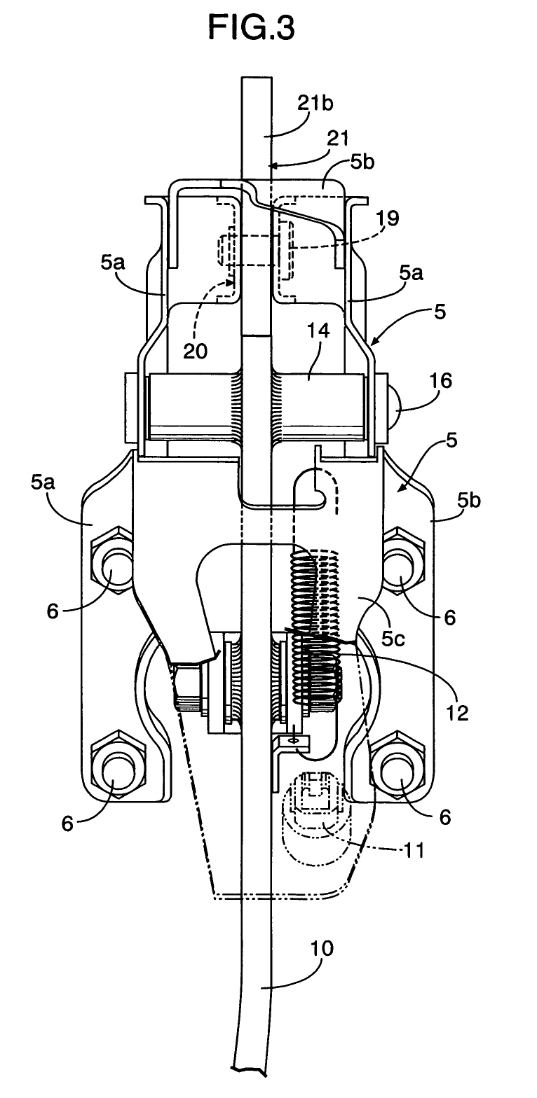

A first embodiment of the present invention shown in FIGS. 1 to 7 will be described.

In FIGS. 1 to 3, firmly fixed by a plurality of bolts 6 to a dashboard 3 of a vehicle body separating an engine room 1 in a front part and a vehicle compartment 2 in a rear part in an automobile, are a negative pressure booster 4 placed in the engine room 1 and a bracket 5 placed in the vehicle compartment 2. Mounted on a front face of the negative pressure booster 4 is a brake master cylinder 7 boosted by the negative pressure booster 4. Connected to an output port of the brake master cylinder 7 is a hydraulic conduit pipe (not shown) coupled to wheel cylinders of a front wheel brake and a rear wheel brake.

The bracket 5 comprises: a pair of left and right sidewall plates 5a, 5a with their front ends fixed to the dashboard 3 by the bolts 6, 6; a ceiling plate 5b integrally connecting together upper ends of the sidewall plates 5a, 5a; and a rear wall plate 5c integrally connecting together rear ends of the pair of sidewall plates 5a, 5a. An upper end of a brake pedal 10 is pivotally supported on both the sidewall plates 5a, 5a. A clevis 8 is provided at a rear end of an input lever 4a of the negative pressure booster 4 which passes through the dashboard 3, and is coupled via a coupling shaft 9 to an intermediate portion of the brake pedal 10. A stop switch 11 for lighting up a stop lamp provided at a tail of the vehicle body in response to advancement of the brake pedal 10 from its retreated position is mounted on the rear wall plate 5c. A return spring 12 urging the brake pedal 10 in a retreating direction is connected between the bracket 5 and the brake pedal 10.

Now, a structure supporting the brake pedal 10 will be described in detail.

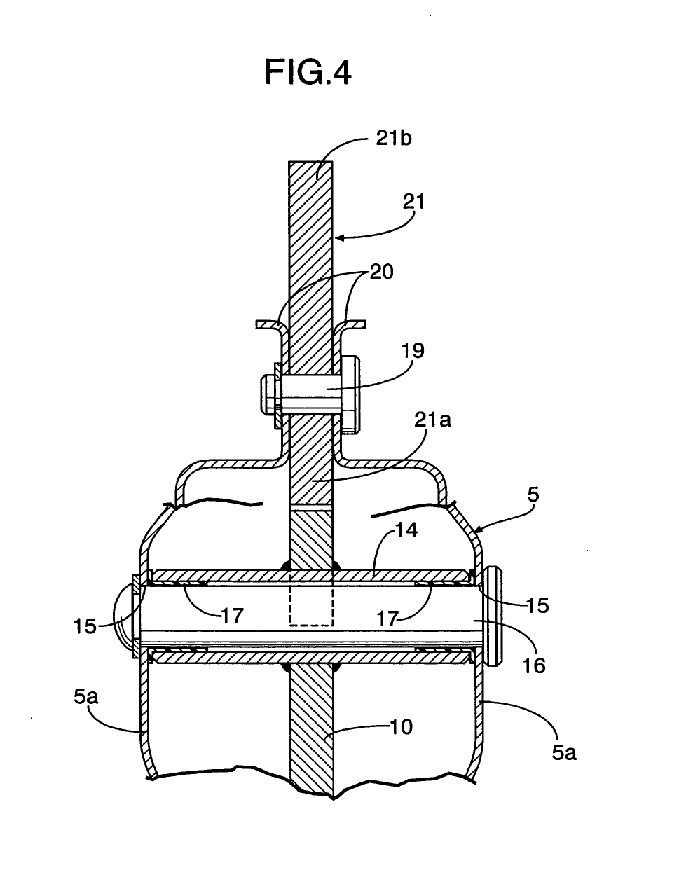

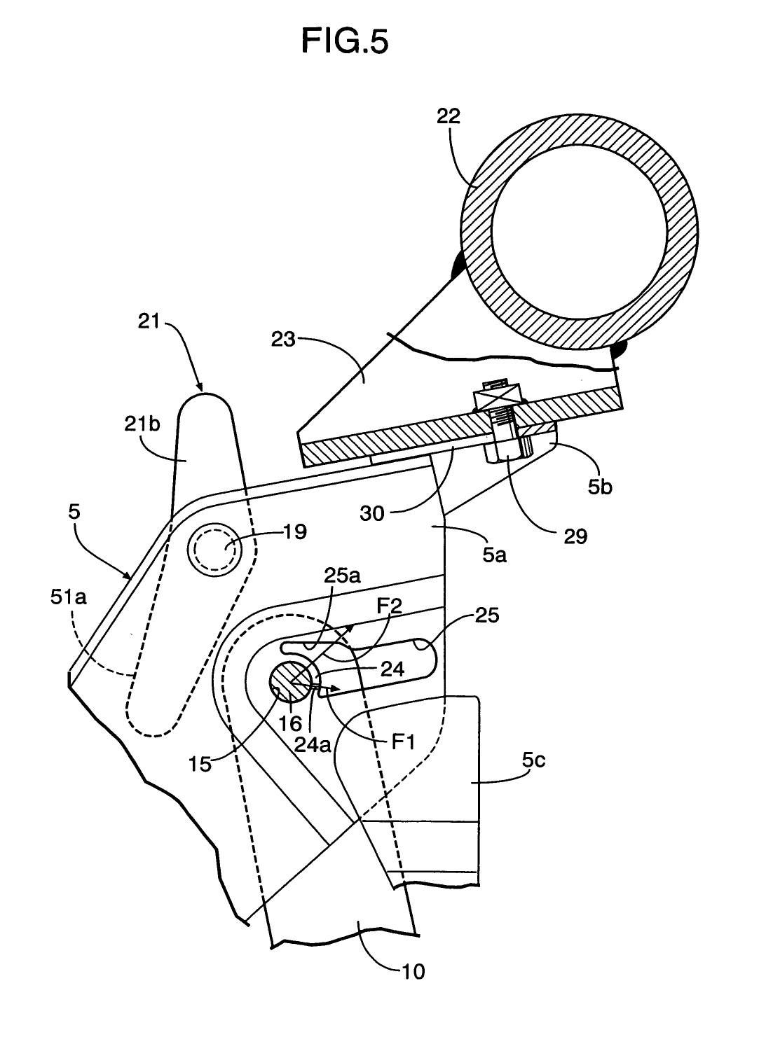

As shown in FIGS. 4 and 5, a support pipe 14 is fixedly provided at the upper end of the brake pedal 10 by welding, and is relatively rotatably supported via bearing bushes 17, 17 by a pivot 16 with its opposite ends supported by a support hole 15 provided in both the sidewall plates 5a, 5a.

Thus, when a driver depresses forward a tread portion 10a of the bake pedal 10, the brake pedal 10 rotates forward around the pivot 16 to press forward the input lever 4a, whereby the negative pressure booster 4 boosts the brake master cylinder 7, so that the brake master cylinder 7 supplies a hydraulic pressure generated therein to the front wheel brake and the rear wheel brake to operate them. At this time, a brake reactive force F1 applied on the brake pedal 10 acts in a direction shown by an arrow (see FIG. 5) from the pivot 16 to the inner face of the support hole 15.

Provided between the upper parts of the left and right sidewall plates 5a, 5a is a narrowed portion 20 where the distance between the sidewall plates 5a, 5a is reduced. A control lever 21 is rotatably supported by a support shaft 19 supported in parallel with the pivot 16 by the narrowed portion 20. The control lever 21 has an upper arm 21b and a lower arm 21a protruding respectively in upward and downward directions from the support shaft 19. A stopper member 23 is fixedly provided on a steering hanger beam 22 which is a reinforcement member of the vehicle body, and is placed opposite to the rear of the upper arm 21b in the rear of the upper arm 21b. The lower arm 21a faces the front face of the brake pedal 10 near the pivot 16 with a small gap provided therebetween. At this time, the support shaft 19 of the control lever 21 is placed such that a distance A between the support shaft 19 and the pivot 16 is smaller than a distance B between the pivot 16 and the coupling shaft 9. When the control lever 21 rotates around the support shaft 19 counterclockwise as shown in FIG. 5, the lower arm 21a presses a front face of the upper end of the brake pedal 10 to apply to the pivot 16 a load F2 in a direction displaced from a line of action of the brake reactive force F1. A long hole 25 extending along a line of action of the load F2 is provided in the sidewall plates 5a, 5a so that the long hole 25 is adjacent to the support hole 15 with a partition wall 24 provided therebetween. A fragile portion 24a having a groove is formed at one end of the partition wall 24. When the partition wall 24 receives the excessive load F2 from the pivot 16, the fragile portion 24a is broken. The long hole 25 receives the pivot 16 which has broken the partition wall 24, and guides the pivot 16 rearward. A recess 25a for receiving the partition wall 24 deformed due to the breakage of the fragile portion 24a is provided on one side of the long hole 25.

The stopper member 23 and the ceiling plate 5b of the bracket 5 are coupled to each other by a bolt 29 to be relatively slidable in a back-and-forth direction. At this time, a bolt hole 30 of the ceiling plate 5b into which the bolt 29 is inserted is formed into a notch shape so as to accommodate forward detachment of the bolt 29.

The operation of the first embodiment will now be described.

During a normal brake operation in which a driver depresses forward the tread portion 10a of the brake pedal 10, the brake reactive force F1 acts on the inner face of the support hole 15 of the bracket 5 from the pivot 16. However, because the partition wall 24 and the long hole 25 are provided outside the line of action of the brake reactive force F1, the partition wall 24 is never broken by the brake reactive force F1, thus reliably transmitting a brake force to the input lever 4a of the negative pressure booster 4. Further, because the support hole 15 supporting the pivot 16 can be formed into a circular shape conforming to the outer peripheral face of the pivot 16 by virtue of the partition wall 24, no rattling occurs between the support hole 15 and the pivot 16, thus providing an excellent operation feeling of the operating pedal.

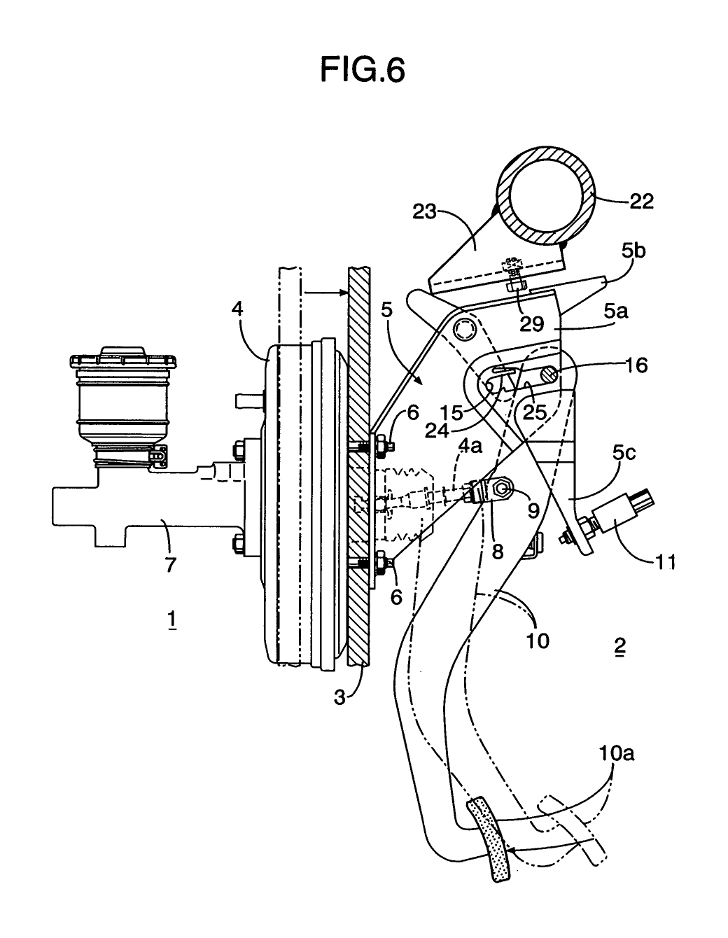

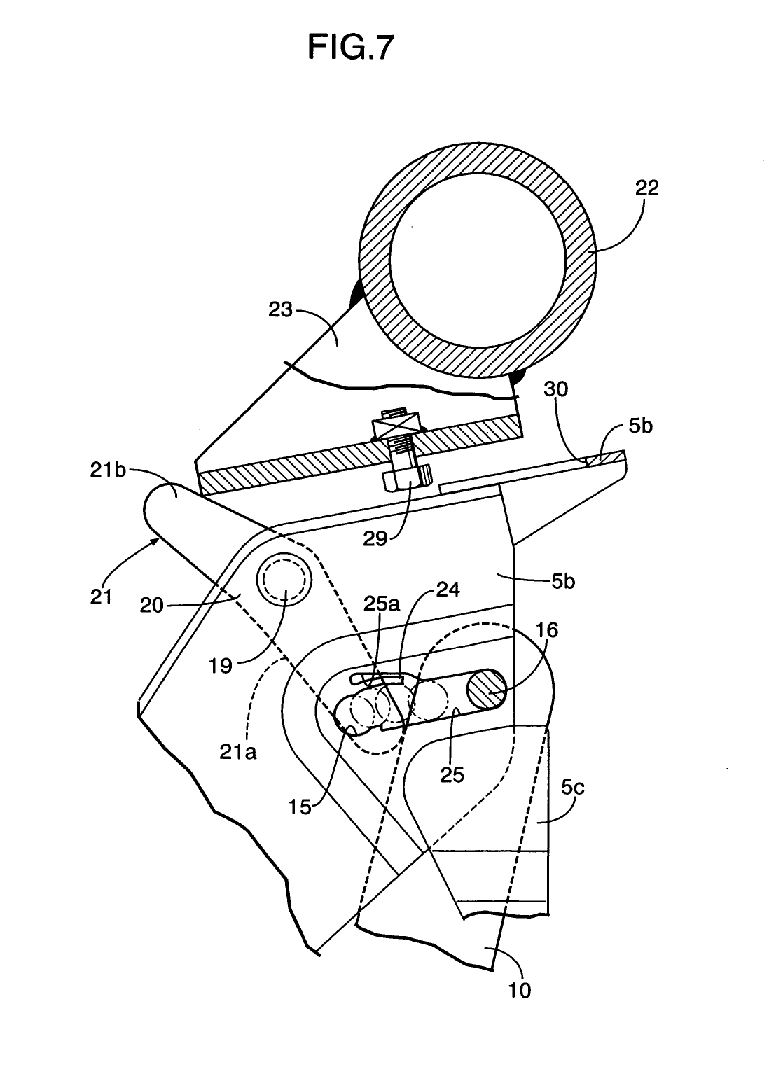

In the case where an excessive load acts from the front onto the brake master cylinder 7 and the negative pressure booster 4 due to head-on collision of the vehicle, as shown in FIGS. 6 and 7, and thus the deformation of the dashboard 3 largely displaces the bracket 5 rearward, the ceiling plate 5b of the bracket 5 slides rearward with respect to the stopper member 23, the bolt 29 is detached from the bolt hole 30, the upper arm 21b of the control lever 21 bumps against the stopper member 23, the counter action thereof causes the control lever 21 to rotate counterclockwise as shown in FIG. 6, and the lower arm 21a strongly presses the pivot 16 toward the partition wall 24 via the brake pedal 10, so that the fragile portion 24a of the partition 24 is broken. As a result, the pivot 16 moves rearward within the long hole 25 while pushing the broken partition wall 24 into the recess 25a provided on one side of the long hole 25, and accordingly the brake pedal 10 rotates clockwise around the coupling shaft 9 coupled to the input lever 4a as shown in FIG. 6, thereby displacing forward the tread portion 10a of the brake pedal 10. Thus, the driver receives no kickback from the brake pedal 10 during a brake operation.

As described above, the distance A between the support shaft 19 and the pivot 16 is set to be smaller than the distance B between the pivot 16 and the coupling shaft 9, and this arrangement is effective in changing the line of action of the brake reactive force F1 acting on the pivot 16 and the line of action of the excessive load F2 given to the pivot 16 by the control lever 21. Therefore, only upon head-on collision, the excessive load F2 from the control lever 21 can be reliably exerted on the partition wall 24 placed on the line of action of the excessive load F2

Because the fragile portion 24a is provided at one end of the partition wall 24 and the recess 25a receiving the partition wall 24 broken at the fragile portion 24a is provided on one side of the long hole 25, the pivot 16 can move within the long hole 25 without being interrupted by the partition wall 24 by pushing the broken partition wall 24 into the recess 25a upon head-on collision, thereby achieving a desired effect.

In the first embodiment above, the ceiling plate 5b of the bracket 5 can be simply placed to be slidable with respect to the stopper member 23 without using the bolt 29.

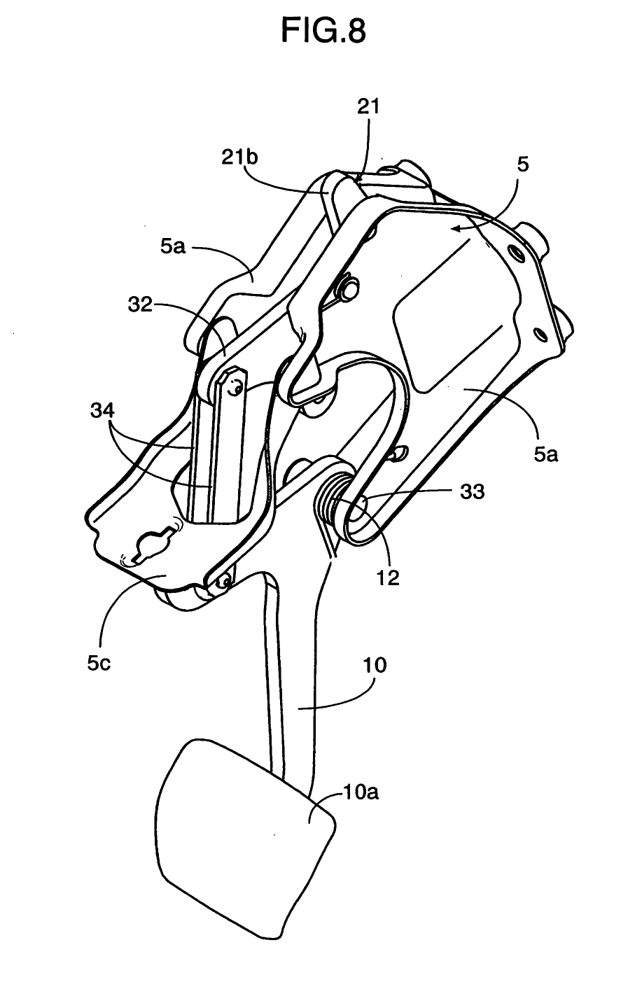

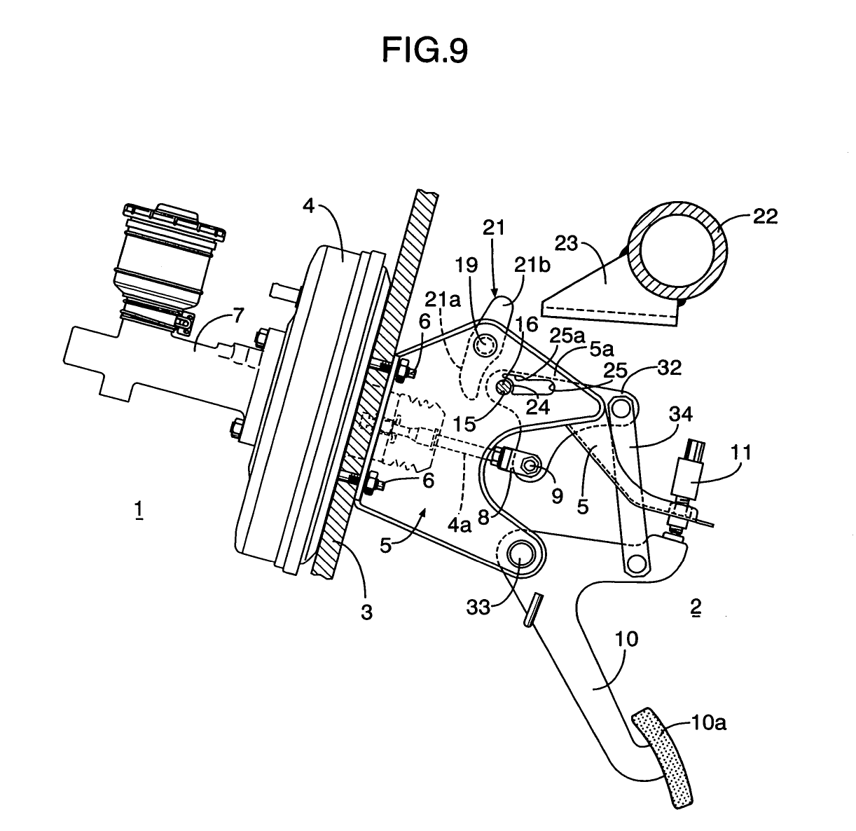

A second embodiment of the present invention shown in FIGS. 8 to 10 will now be described.

A bell-crank shaped relay lever 32 is coupled via the coupling shaft 9 to the input lever 4a and supported by the pivot 16. The lower arm 21a of the control lever 21 is placed to face a front face of the relay lever 32 near the pivot 16.

The brake pedal 10 is supported via another pivot 33 by the bracket 5 below the relay lever 32, and coupled via a link 34 to the relay lever 32. The other components are substantially same as those of the first embodiment, and thus the same reference numerals and symbols are given to components in FIGS. 8 to 10 corresponding to those of the first embodiment, and redundant explanations are omitted.

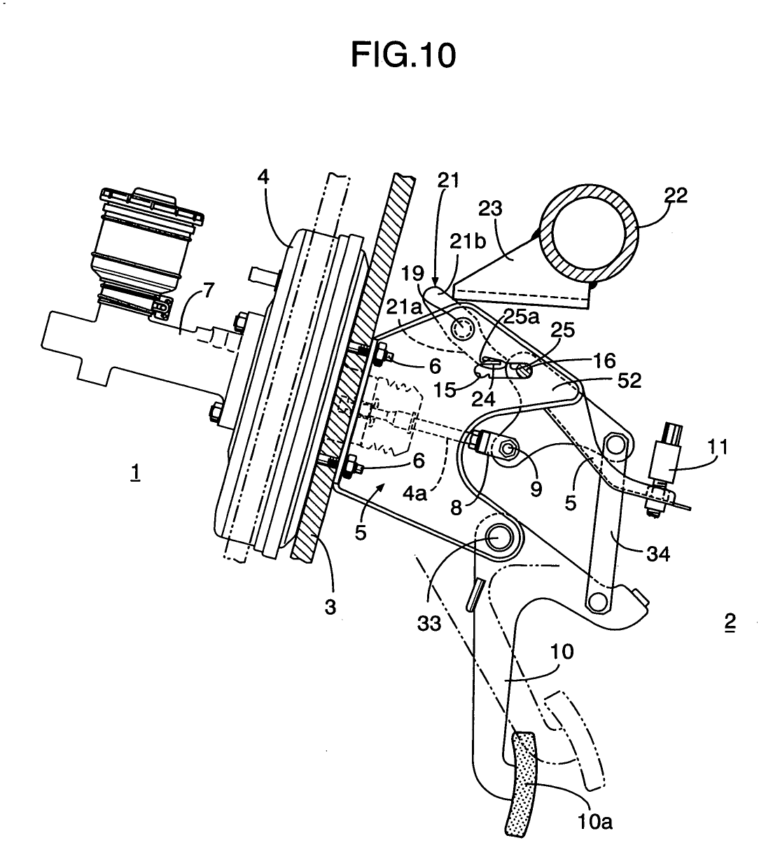

According to the second embodiment, the speed of movement of the brake pedal 10 can be increased or decreased and transmitted to the input lever 4a by arbitrarily setting a lever ratio between the brake pedal 10 and the relay lever 32 as well as an input-side lever ratio and an output-side lever ratio in the relay lever 32. When the control lever 21 abuts against the stopper member 23 upon head-on collision and rotates counterclockwise as shown in FIG. 10, and the pivot 16 breaks the partition wall 24 and moves rearward within the long hole 25, the relay lever 32 rotates clockwise around the coupling shaft 9, and rotates via the link 34 the brake pedal 10 around the pivot 37 clockwise as shown in FIG. 10, whereby the tread portion 10a can be displaced forward.

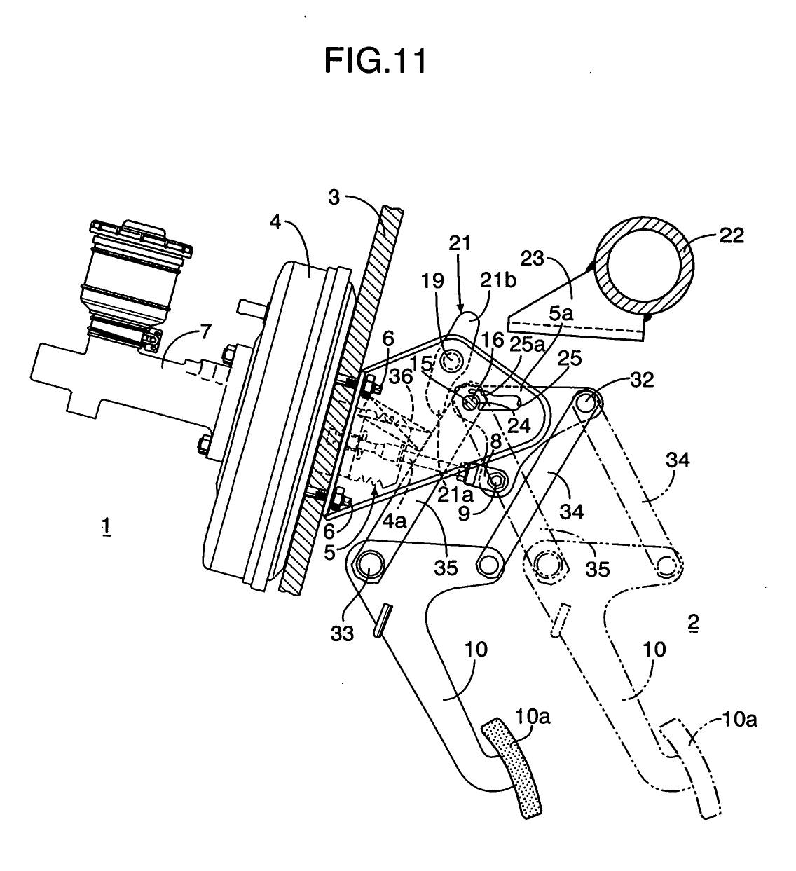

Finally, a third embodiment of the present invention shown in FIG. 11 will be described.

In the third embodiment, the retreated position of the brake pedal 10 can be adjusted, in addition to the features of the second embodiment. That is, a pedal support link 35 is rotatably supported by the pivot 16 or another pivot adjacent thereto, and a pedal adjusting means 36 capable of fixing the pedal support link 35 at any rotational position is provided between the pedal support link 35 and the bracket 5. In a state in which the pedal support link 35 and the link 34 are parallel with each other, the pedal support link 35 and the brake pedal 10 are coupled to each other via the pivot 37. The other components are substantially same as those of the second embodiment, and thus the same reference numerals and symbols are given to components in FIG. 11 corresponding to those of the second embodiment, and redundant explanations are omitted.

According to the third embodiment, when the pedal support link 35 is swung back and forth by the pedal adjusting means 36, the brake pedal 10 is moved in the same posture by cooperation between the pedal support link 35 and the link 34, thereby adjusting the position of the tread portion 10a when the brake pedal 10 is at the retreated position so as to be agreeable to the physical constitution of the driver. When the pedal support link 35 is fixed by the pedal adjusting means 36, the pedal support link 35 becomes integral with the bracket 5, so that the brake pedal 10 is supported substantially by the bracket 5, and thereafter the same effect as the second embodiment can be exhibited.

The present invention is not limited to the above-described embodiments, and various changes in design can be made thereto within the scope of the subject matter of the present invention. For example, the present invention is also applicable to a clutch system.

What is claimed is:

1. An operating pedal system of an automobile in which an operating pedal for operating an operation device mounted on a front face of a dashboard of a vehicle body or a relay lever associated with the operating pedal is mounted on a bracket fixedly provided on a rear face of the dashboard via a pivot,
wherein a support hole supporting the pivot and a long hole adjacent to the support hole and extending rearward thereof are pivotally supported on the bracket such that a partition wall is provided between the support hole and the long hole, a control lever is pivotally supported on a front face of the pivot via the operating pedal or the relay lever such that a lower arm of the control lever faces the front face, and a stopper member fixedly provided on a reinforcement member of the vehicle body faces an upper arm of the control lever from behind, so that, when the control lever abuts against the stopper member and rotates as the dashboard is deformed rearward, the pivot breaks the partition wall to move rearward within the long hole due to an excessive load received from the control lever.

2. The operating pedal system of an automobile according to claim 1, wherein a fragile portion to be broken by the excessive load is provided at one end of the partition wall, and a recess receiving the partition wall deformed by the breakage of the fragile portion is formed on one side of the long hole.
